(19) United States
(12) Patent Application Publication
(10) Pub. No.: US 2015/0338512 A1
(43) Pub. Date: Nov. 26, 2015

(54) ROUND TRIP TIME ACCURACY IMPROVEMENT IN VARIED CHANNEL ENVIRONMENTS

(71) Applicant: QUALCOMM Incoporated, San Diego, CA (US)

(72) Inventors: Sandip HomChaudhuri, San Jose, CA (US); Carlos Horacio Aldana, Mountain View, CA (US); Xiaoxin Zhang, Fremont, CA (US); Sumeet Kumar, San Jose, CA (US)

(73) Assignee: QUALCOMM Incoporated, San Diego, CA (US)

(21) Appl. No.: 14/286,341

(22) Filed: May 23, 2014

(51) Int. Cl. G01S 11/02

(52) U.S. Cl. CPC G01S 11/02

(57) ABSTRACT

Methods, systems, and devices are described that provide for wireless ranging. The methods, systems, and/or devices may include tools and techniques that provide for determining a range based on a TOD and a TOA that is adjusted based on a mean FAC. A probe may be transmitted from a transmitter to a receiver. The transmitter may receive a response, from the receiver. A strongest path within the response may be identified. A threshold may be determined. A plurality of FAC values may be identified, which exceed the threshold and precede the strongest path within the response. After the plurality of FAC values are identified, a mean FAC may be determined based at least in part on the plurality of FAC values. A TOA of the response may be adjusted based on the mean FAC. A range to the receiver may be determined based on a TOD and the adjusted TOA.

### BACKGROUND

The following relates generally to wireless communication, and more specifically to detecting the distance from a transmitter to a receiver. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. A ranging operation may be performed between a receiver and a transmitter. The ranging operation may include transmitting a probe with a recorded time-of-departure (TOD), and receiving a response responsive to the probe including a recorded time-of-arrival (TOA). The TOD and TOA may be used to calculate a range between the transmitter and receiver. Multiple impulse responses may be received by the transmitter representing several multipath components. The strongest path may be identified, which represents the sum of a number of multipath components. From the strongest response, the shortest path may be found by working backwards in time through the response, within a reasonable window, to find a response which exceeds a threshold. The response that is found, or first arrival correction (FAC), is assumed to be the shortest path and may be used to adjust the TOA and therefore affect a determined range from the transmitter to the receiver. A fixed threshold is prone to error, as there are a variety of environments in which a ranging operation may be performed such as with line-of-sight (LOS) visibility or non-line-of-sight (NLOS) visibility, and a high or low signal-to-noise ratio (SNR).

### SUMMARY

Described below are methods, systems, and devices that provide for wireless ranging. A probe may be transmitted from a transmitter (e.g., a mobile device) to a receiver (e.g., an access point). The transmitter may receive a response from the receiver that indicates receipt of the probe. A strongest path within the response may be identified. A threshold may be determined. A plurality of FAC values may be identified, which exceed the threshold and precede the strongest path within the response. In some cases, only values occurring within a search window are analyzed as potential FAC values. After the plurality of FAC values are identified, a mean FAC may be determined based at least in part on the plurality of FAC values. A TOA of the response may be adjusted based on the mean FAC. A range from the transmitter to the receiver may be determined based at least in part on a TOD and the adjusted TOA.

In some embodiments, a method for wireless ranging includes receiving a signal comprising a frame from a transmitter, identifying a first value for the frame, and identifying a plurality of first arrival correction (FAC) values for the frame, each FAC value exceeding a threshold, wherein the plurality of FAC values precede the identified first value within the frame.

In some embodiments, an apparatus for wireless ranging includes a receiver configured for receiving, from a transmitter, a signal comprising a frame, a path identifier configured for identifying a first value for the frame, and a corrector configured for identifying a plurality of first arrival correction (FAC) values for the frame, each FAC value exceeding a threshold, wherein the plurality of FAC values precede the identified first value within the frame.

In some embodiments, an apparatus for wireless ranging includes means for receiving, from a transmitter, a signal comprising a frame, means for identifying a first value for the frame, and means for identifying a plurality of first arrival correction (FAC) values for the frame, each FAC value exceeding a threshold, wherein the plurality of FAC values precede the identified first value within the frame.

In some embodiments, a computer-program product for wireless ranging includes a non-transitory computer-readable medium storing instructions executable by a processor to receive, from a transmitter, a signal comprising a frame, identify a first value for the frame, and identify a plurality of first arrival correction (FAC) values for the frame, each FAC value exceeding a threshold, wherein the plurality of FAC values precede the identified first value within the frame.

Various embodiments of the method, apparatuses, and/or computer program product may include the features of, modules for, and/or processor-executable instructions for determining a mean FAC value, wherein the mean FAC value is based at least in part on the plurality of FAC values. The threshold may be based at least in part on a noise power. In some cases, the plurality of FAC values comprise a plurality of searched FAC values which each exceed the threshold, wherein the plurality of searched FAC values each occur within a search window. The plurality of FAC values may be weighted proportional to a power of each FAC value. In some cases, the plurality of FAC values are weighted inversely proportional to a power of each FAC value.

Various embodiments of the method, apparatuses, and/or computer program product may include the features of, modules for, and/or processor-executable instructions for determining a range to the transmitter based at least in part on the mean FAC value. Identifying the plurality of FAC values which each exceed the threshold may include determining an appropriate threshold, wherein the appropriate threshold is one of a plurality of thresholds, and identifying the plurality of first arrival correction (FAC) values which each exceed the appropriate threshold. In some cases, at least one of the plurality of thresholds is based at least in part on a noise power. At least one of the plurality of thresholds may be based at least in part on the first value for the frame. In some cases, determining an appropriate threshold is based at least in part on at least one of a signal to noise ration and a visibility environment. The first value for the frame may include a maximum value for the frame. In some cases, the frame includes a time of departure (TOD) and a time of arrival (TOA).

Various embodiments of the method, apparatuses, and/or computer program product may include the features of, modules for, and/or processor-executable instructions for adjusting the TOA based at least in part on the plurality of FAC values.

Various embodiments of the method, apparatuses, and/or computer program product may include the features of, modules for, and/or processor-executable instructions for determining a range to the transmitter based at least in part on the TOD and the adjusted TOA. In some cases, the frame includes at least one of a probe and a response indicating receipt of a probe.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a wireless communications system in accordance with various embodiments;

FIG. 2 shows a call flow diagram that illustrates an example of wireless ranging in a wireless communication system in accordance with various embodiments;

FIGS. 3A and 3B show illustrations of example probe responses in accordance with various embodiments;

FIG. 3C shows a flow diagram that illustrates a method for determining a threshold to use, according to various embodiments;

FIGS. 4A and 4B show block diagrams of an example device(s) that may be employed in wireless communications systems in accordance with various embodiments;

FIG. 5 shows a block diagram of a mobile device configured for wireless ranging in accordance with various embodiments;

FIG. 6 shows a block diagram of a communications system that may be configured for wireless ranging in accordance with various embodiments; and

FIGS. 7 and 8 are flow diagrams that depict a method or methods of wireless ranging in accordance with various embodiments.

### DETAILED DESCRIPTION

The methods, systems, and/or devices may include tools and techniques that provide for varied wireless ranging environments. For example, wireless ranging may be performed based on an adaptive threshold that changes according to channel conditions. In some cases, wireless ranging may be performed based on a mean FAC, which is based on a plurality of FAC values. The mean FAC may be determined based on weighted FAC values, such as weighted relating to proximity to a strongest path and/or relating to an impulse power.

Wireless ranging may be based on a round trip time, such as a TOD and a TOA that is adjusted based on a mean FAC. A probe may be transmitted from a transmitter (e.g., a mobile device) to a receiver (e.g., an access point). The transmitter may receive a response indicating receipt of the probe, from the receiver. A strongest path within the response may be identified and a threshold may be determined. A plurality of FAC values may be identified, which exceed the threshold and precede the strongest path within the response. After the plurality of FAC values are identified, a mean FAC may be determined based at least in part on the plurality of FAC values. A TOA of the response may be adjusted based on the mean FAC and a range to the receiver may be determined based on a TOD and the adjusted TOA

Thus, the following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

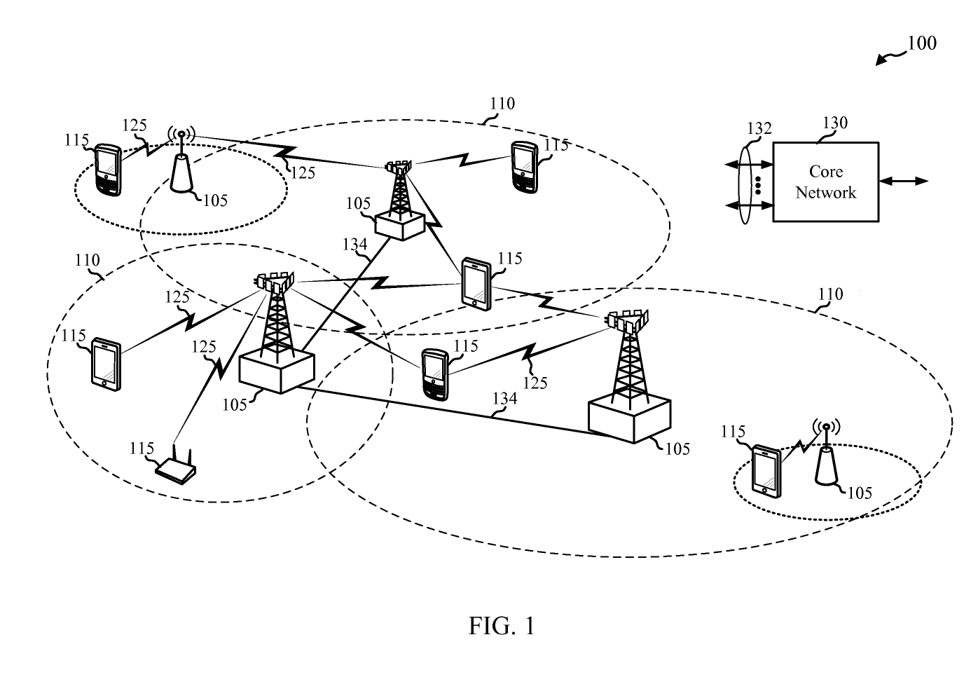

FIG. 1 shows a diagram illustrating an example of a wireless communications system 100 in accordance with various aspects of the present disclosure. The wireless communication system 100 includes a plurality of base stations 105 (e.g., evolved NodeBs (eNBs), wireless local area network (WLAN) access points, or other access points), a number of mobile devices 115, and a core network 130. Some of the base stations 105 may communicate with the mobile devices 115 under the control of a base station controller (not shown), which may be part of the core network 130 or certain ones of the base stations 105 in various examples. Some of the base stations 105 may communicate control information and/or user data with the core network 130 through backhaul 132. In some examples, some of the base stations 105 may communicate, either directly or indirectly, with each other over backhaul links 134, which may be wired or wireless communication links. The wireless communication system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., pilot symbols, reference signals, control channels, etc.), overhead information, data, etc. The system 100 may be a multi-carrier long-term evolution (LTE) network capable of efficiently allocating network resources.

The base stations 105 may wirelessly communicate with the mobile devices 115 via one or more base station antennas. Each of the base stations 105 may provide communication coverage for a respective coverage area 110. In some examples, a base station 105 may be referred to as an access point, a base transceiver station (BTS), a radio base station, a radio transceiver, a basic service set (BSS), an extended service set (ESS), a NodeB, an evolved NodeB (eNB), a Home NodeB, a Home eNodeB, a WLAN access point, a WiFi node or some other suitable terminology. The coverage area 110 for a base station 105 may be divided into sectors making up only a portion of the coverage area (not shown).

The wireless communication system 100 may include base stations 105 of different types (e.g., macro, micro, and/or pico base stations). The base stations 105 may also utilize different radio technologies, such as cellular and/or WLAN radio access technologies. The base stations 105 may be associated with the same or different access networks or operator deployments. The coverage areas of different base stations 105, including the coverage areas of the same or different types of base stations 105, utilizing the same or different radio technologies, and/or belonging to the same or different access networks, may overlap.

The core network 130 may communicate with the base stations 105 via a backhaul 132 (e.g., S1 application protocol, etc.). The base stations 105 may also communicate with one another, e.g., directly or indirectly via backhaul links 134 (e.g., X2 application protocol, etc.) and/or via backhaul 132 (e.g., through core network 130). The wireless communication system 100 may support synchronous or asynchronous operation. For synchronous operation, the base stations may have similar frame and/or gating timing, and transmissions from different base stations may be approximately aligned in time. For asynchronous operation, the base stations may have different frame and/or gating timing, and transmissions from different base stations may not be aligned in time. The techniques described herein may be used for either synchronous or asynchronous operations.

The mobile devices 115 may be dispersed throughout the wireless communication system 100, and each mobile device 115 may be stationary or mobile. A mobile device 115 may also be referred to by those skilled in the art as a user equipment (UE), a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A mobile device 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A mobile device 115 may be able to communicate with macro eNBs, pico eNBs, femto eNBs, relays, and the like. A mobile device 115 may also be able to communicate over different types of access networks, such as cellular or other wireless wide area network (WWAN) access networks, or WLAN access networks. In some modes of communication with a mobile device 115, communication may be conducted over a plurality of communication links 125 or channels (i.e., component carriers), with each channel or component carrier being established between the mobile device and one of a number of cells (e.g., serving cells, which in some cases may be different base stations 105).

The communication links 125 shown in wireless communication system 100 may include uplink channels (or component carriers) for carrying uplink (UL) communications (e.g., transmissions from a mobile device 115 to a base station 105) and/or downlink channels (or component carriers) for carrying downlink (DL) communications (e.g., transmissions from a base station 105 to a mobile device 115). The UL communications or transmissions may also be called reverse link communications or transmissions, while the DL communications or transmissions may also be called forward link communications or transmissions.

In certain examples of the present disclosure, a base station 105 may perform a wireless ranging operation with a mobile device 115. Alternatively, a mobile device 115 may perform a wireless ranging operation with a base station 105. In some cases, a ranging operation is affected by a signal to noise ratio and/or a visibility environment (e.g., line-of-sight (LOS) or non-line-of-sight (NLOS) environments). In various embodiments, the strongest detected path, which is often used for ranging, may include multiple components representing different paths taken by a ranging signal. In some cases, an accurate range may be determined by using a weaker signal, which is received prior to the reception of the strongest path in time, which represents a shorter path. However, it is important that the shorter path exceeds a reliable threshold, and can therefore be distinguished from system noise.

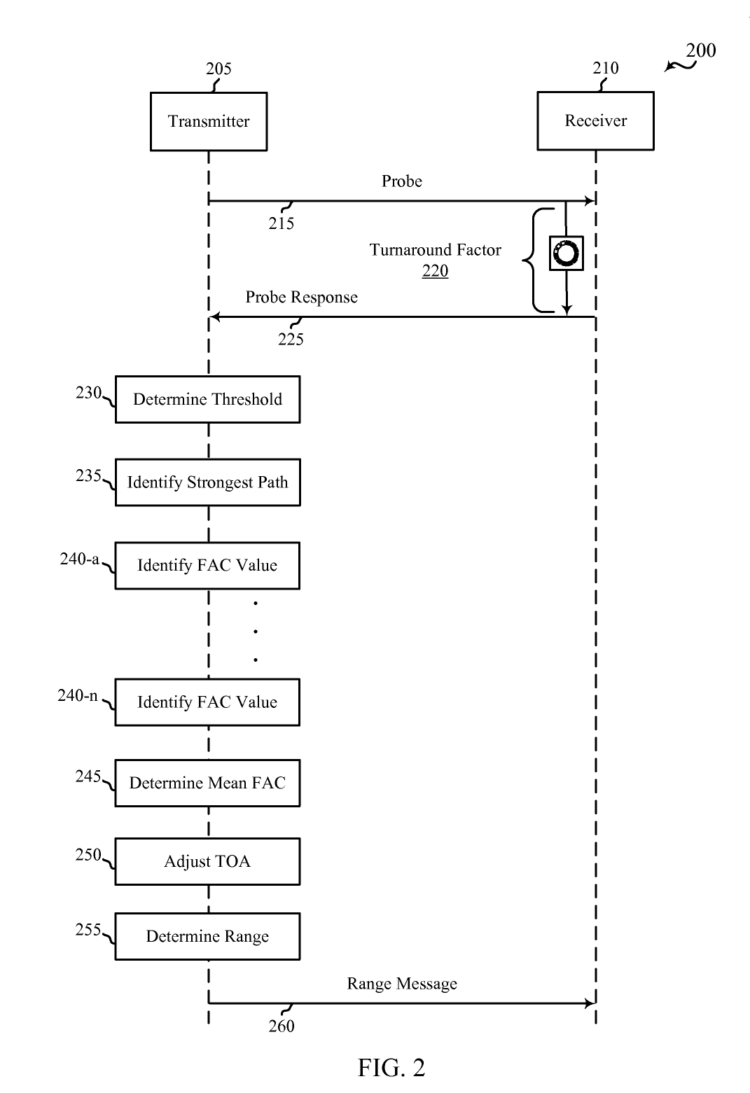

FIG. 2 shows a call-flow diagram 200, which illustrates, according to some embodiments, communication within a system configured for wireless ranging. FIG. 2 shows communication between a transmitter 205 and a receiver 210. The transmitter 205 may be an example of the base station 105 or mobile device 115 of FIG. 1. The receiver 210 may be an example of the base station 105 or mobile device 115 of FIG. 1.

A probe 215 may be transmitted from the transmitter 205 to the receiver 210. In some cases, the probe 215 includes a time-of-departure (TOD). The receiver 210 may transmit a probe response 225 to the transmitter 205. In various embodiments, the probe response 225 is transmitted after a turnaround calibration factor (TCF) 220. The TCF 220 may be known in the system or may be calculated. In some cases the TCF 220 is included in the probe response 225. The probe response 225 may include an acknowledgment (ACK) message confirming receipt of the probe 215.

The transmitter 205 may determine a threshold to use 230. The threshold may be used to distinguish received signals, such as the probe response 225, from system noise. In some cases, the system includes a plurality of thresholds and the choice of threshold may be based on a signal-to-noise ratio (SNR) of the system and/or a visibility environment, such as whether the environment is LOS or NLOS. The transmitter 205 may identify a strongest path 235 of the probe response 225. A time-domain channel impulse response (CIR) may be used to determine the strongest path. For example, the strongest path may be a sample, or impulse, with the strongest power. When identifying the strongest path 235, the transmitter 205 may determine a time-of-arrival (TOA) for the probe response 225, such as based on the TOA of the strongest path. The TOD and/or TOA may be recorded at the media access control (MAC) layer. The probe response 225 may include several multipath components. In some embodiments, the MAC and/or physical (PHY) layers base computation, such as recording of TOA, on the strongest path.

The transmitter 205 may identify at least one first arrival correction (FAC) value 240. A time-domain CIR may be used to determine FAC values. In some cases, a FAC value is an impulse, or sample, which exceeds the chosen threshold. The FAC value may be received by the transmitter 205 before the strongest path is received, with respect to time. In some cases, the transmitter 205 starts from the impulse response of the strongest path, and works backwards (with respect to time) to identify at least one FAC value which exceeds the chosen threshold.

In some cases, the transmitter 205 determines a mean FAC 245. The mean FAC may be based at least in part on the at least one identified FAC value. In some cases, the mean FAC is calculated based on all of the identified FAC values as identified at blocks 240-a through 240-n. In some embodiments, the mean FAC is calculated based on a subset of the identified FAC values as identified at blocks 240-a through 240-n. In some cases, the mean FAC is an average of the identified FAC values. In various embodiments, the FAC values may be weighted. For example, the FAC values may be weighted proportional to a CIR power of the sample. The FAC values may be weighted inversely proportional to the CIR power of the sample. In some cases, the FAC values are weighted proportional to their proximity to the impulse of the identified strongest path. In some cases, the FAC values are weighted inversely proportional to their proximity to the impulse of the identified strongest path.

The TOA may be adjusted 250 by the transmitter 205. In some cases, the TOA is adjusted based at least in part on the identified FAC values. In various embodiments, the TOA is adjusted based at least in part on the determined mean FAC. In some cases, the TOA is adjusted to the time at which the earliest identified FAC value was received. The transmitter 205 may determine a range 255, such as to the receiver 210, and/or information relating to a range to the receiver 210. In some cases, the range to the receiver is based at least in part on the TOD, the adjusted TOA, and/or the TCF. In various embodiments, the transmitter 205 transmits the determined range 260 to the receiver 210.

It should be noted that operations described above, such as any or all of blocks 230 through 260, may be performed by the transmitter 205, receiver 210, or both. For example, the transmitted probe 215 may include a TOD. The receiver 210 may perform any or all of the operations as described above in relation to blocks 230 through 260 such as to determine and correct a TOA for the transmitted probe 215. The receiver 210 may transmit a probe response 225 and/or a range message 260 with a recorded TOD. In some cases, the transmitter 205 performs some or all of the operations as described above for blocks 230 through 260 such as to determine and correct a TOA for the probe response 225 and/or range message 260. In some cases, the transmitter 205 performs any or all of the operations described above for blocks 230 through 260 based on a TOD for the probe 215 or probe response 225. In other words, a ranging operation, or part of a ranging operation, may be performed for either or both of the probe and the probe response individually, or may be performed for the round trip time from the TOD of the probe 215 to the TOA of the probe response 225, at times taking into account the TCF 220.

Those skilled in the art will recognize that the system and the call flow described above is but one implementation of the tools and techniques discussed herein. The operations, or parts of operations, of the call flow may be rearranged or otherwise modified such that other implementations are possible. Further, all of the operations of the system may be performed, or only some of the operations of the system may be performed. In some cases, an operation of the system may be performed numerous times.

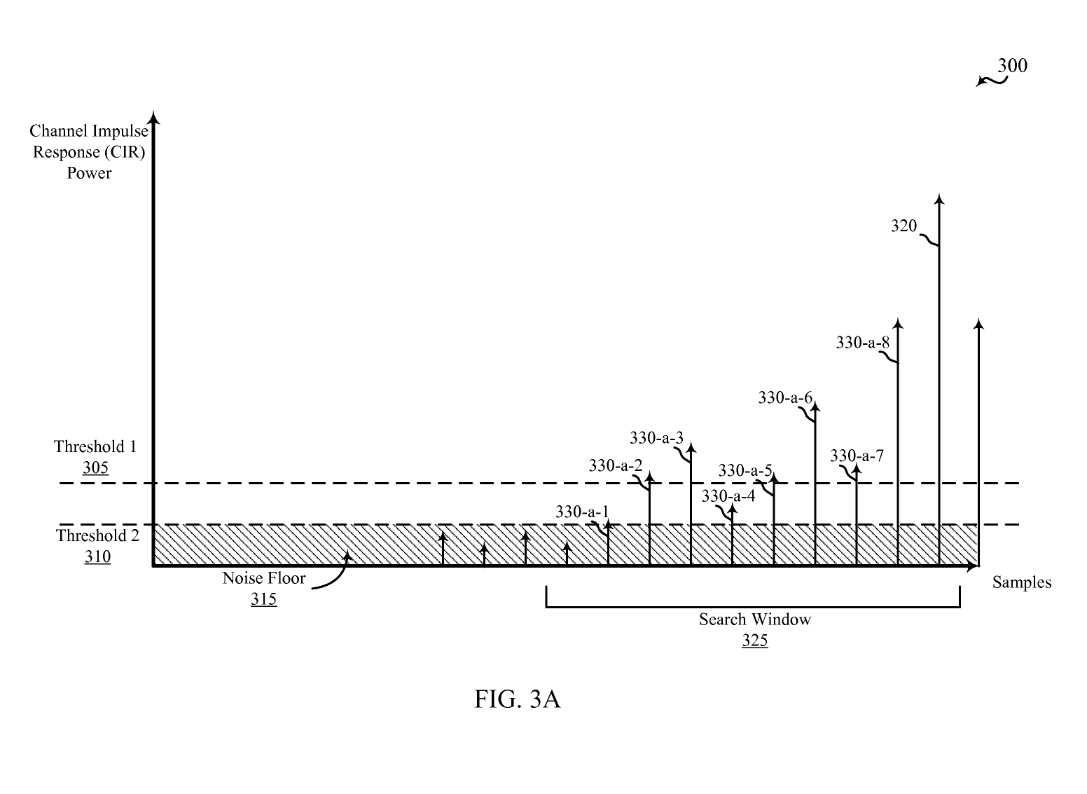

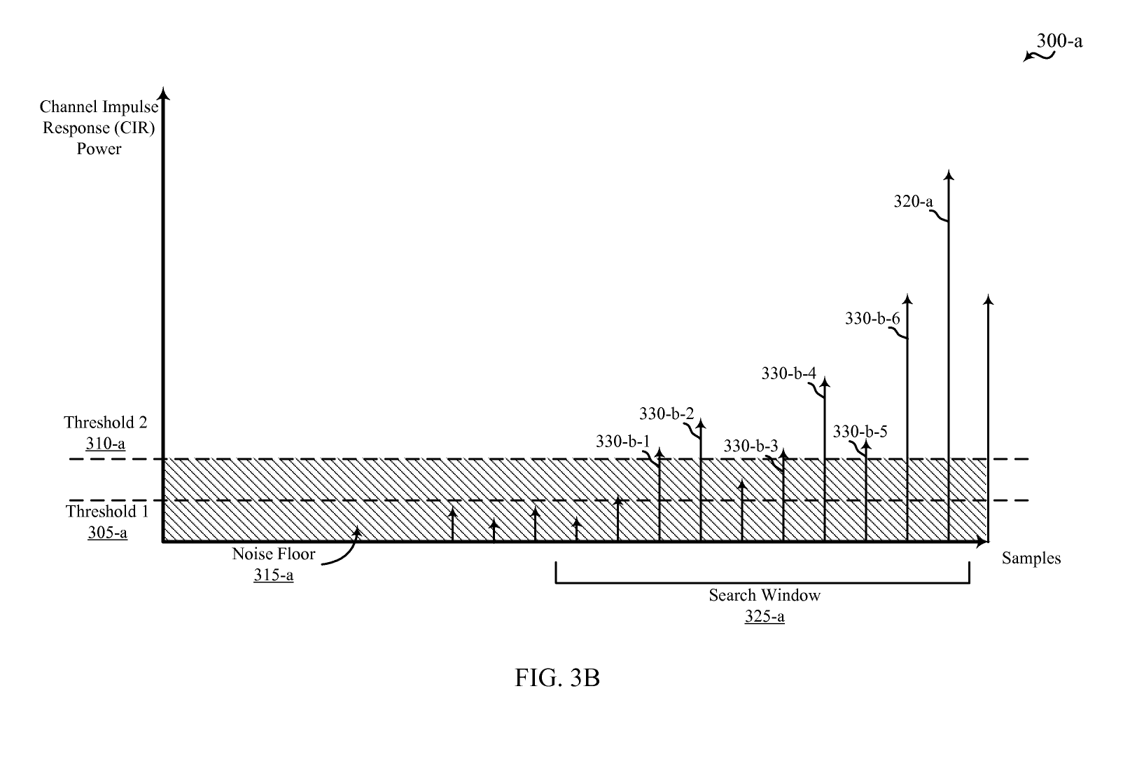

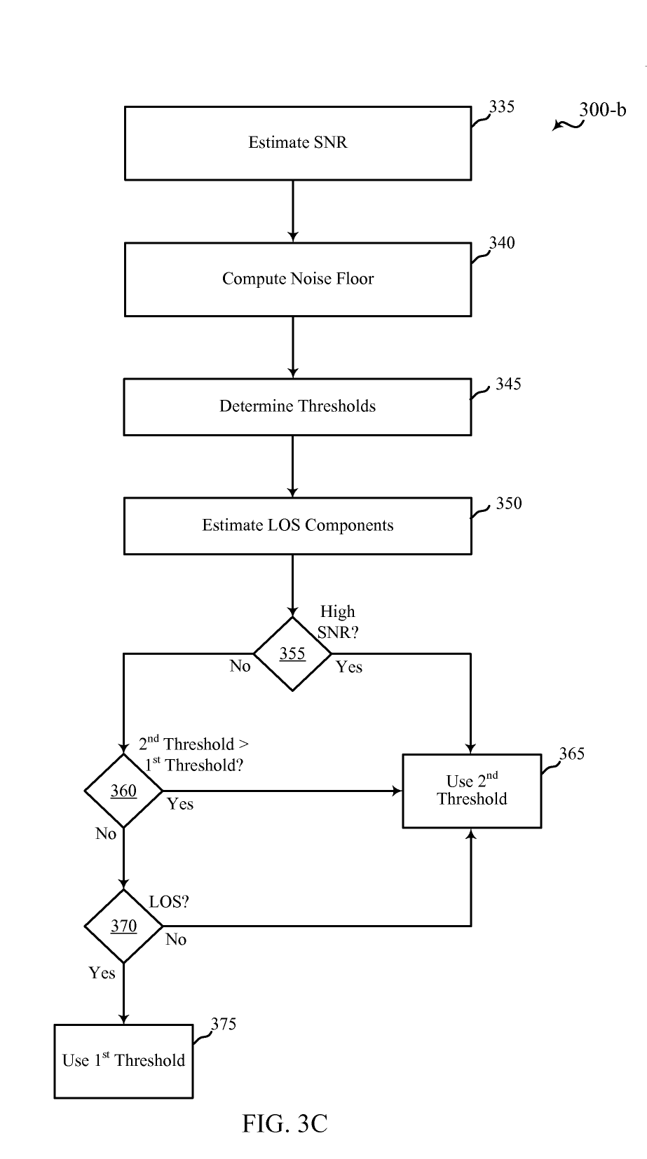

FIG. 3A shows an illustration, according to various embodiments, of a response signal 300 received from a receiver in a system configured for wireless ranging. The signal 300 may be an example of the probe response 225 of FIG. 2. The illustration shows a CIR power for a plurality of received samples. The samples are shown relative to a plurality of thresholds 305 and 310. In some cases, a first threshold 305 (e.g., threshold 1) is a threshold that is determined relative to the CIR power of the strongest impulse response 320, and remains static independent of channel conditions. Threshold 1 may be a conservative threshold to use and may function best in an environment with LOS conditions and high SNR.

In some cases, an adaptive threshold may be introduced, such as a second threshold 310 (e.g., threshold 2). Threshold 2 may be based at least in part on the noise floor 315 of the system. For example, threshold 2 may be a constant, a, multiplied by the noise floor 315. In one embodiment, a is greater than or equal to 1. Increasing the value of a may increase the chances that detected FAC values 330-a-1 to 330-a-8 are not due to noise, while also potentially increasing the chances that legitimate FAC values are missed. It should be noted that at times, the higher the value of a, the closer the second threshold 310 comes to the first threshold 305, which negates the benefits of having a multi-threshold algorithm. In some cases, a may be left open to implementation to select lower values to obtain a FAC value more aggressively, while leaving the error filtering to higher layers with multiple measurement iterations. In various embodiments, a may be changed in a quasi-static manner depending on large scale fading of the channel, such as from gross received signal strength indication (RSSI) and/or SNR. The threshold which is used to determine FAC values 330-a-1 to 330-a-8 may be the minimum of the two thresholds 305 and 310. In some cases, the second threshold 310 replaces the first threshold 305 entirely and a single adaptive threshold is used.

The noise floor 315 may be determined in various ways. For example, at least three ways may be used within an Institute of Electrical and Electronics Engineers (IEEE) 802.11n/ac deployment. First, a portion of the CIR where channel energy is not expected may be used. In a worst case scenario, channel power delay profiles (PDPs) may have about 1 μs of span, or about 300 m of range. A CIR capture may span 3.2 μs, which may result in about 2.2 μs worth of noise samples which may be used to determine the noise floor 315. For example, in a system operating at 20 MHz, with a 128 point Fast Fourier Transform (FFT), this may result in 88 noise samples; in a system operating at 40 MHz, with a 256 point FFT, this may result in 176 noise samples; and in a system operating at 80 MHz, with a 512 point Fast Fourier Transform (FFT), this may result in 352 noise samples. Extensions to 160 MHz or higher are obtained in similar manners. Second, tones that do not have a transmit signal may be used as a source of measurement. For example, in a system operating at 20 MHz, there are 64 tones in the frequency domain with an index from −32 to +31. Only tones from −26 to +26 are carrying information. The tones that are outside of +/−26 (where the bandwidth is greater than or equal to 3.75 MHz) are possible candidates for determining the noise floor 315. Third, a receiver error vector magnitude (EVM) may be used to measure the noise floor 315.

An impulse response of a first value, such as the strongest path 320, may be determined, such as by PHY/MAC layers. From the strongest path 320, impulses which precede the strongest path 320 may be searched for FAC impulses which exceed a threshold, such as the second threshold 310. In some cases, only impulses which occur within a search window 325 are searched for FAC impulses. The search window 325 may be determined in various ways. The search window 325 may span the duration of the worst multipath scenario for which the system is designed. For example, the search window may be based at least in part on a number of samples (N) and/or a sample time (T), such as N*T. T may be chosen for various implementations, such as 25 ns for a 20 MHz system, 12.5 ns for a 40 MHz system, 6.25 ns for an 80 MHz system, 3.125 ns for a 160 MHz system, and so on. This assumes a critically sampled system where the sampling frequency is twice the highest bandwidth supported. In some embodiments, for systems employing a higher sampling rate, T may be smaller. N may be chosen, such as to fill up a 500 ns delay spread, such as 20 for a 20 MHz system, 40 for a 40 MHz system, 80 for an 80 MHz system, and so on. It should be noted that the above mentioned values may be specific to various implementations and values may be representative of a typical channel spread as seen in IEEE 802.11n/ac deployments, which often have a guard interval of 800 ns. Other values may be used as appropriate for the specific system desired.

When using the second threshold 310, a plurality of FAC values 330-a are found, which exceed the second threshold 310 and precede the strongest path 320. It should be noted that there are a number of FAC values 330-a that are found using the second threshold 310 that would not have been found if the first threshold 305 was used on its own.

FIG. 3B shows an illustration, according to various embodiments, of a response signal 300-a received from a receiver in a system configured for wireless ranging. The signal 300-a may be an example of the probe response 225 of FIG. 2. The illustration shows a CIR power for a plurality of received samples. The first threshold 305-a (e.g., threshold 1), the second threshold 310-a (e.g., threshold 2), noise floor 315-a, strongest path impulse 320-a, search window 325-a, and FAC values 330-b may be examples of the first threshold 305, the second threshold 310, noise floor 315, strongest path impulse 320, search window 325, and FAC values 330-a as described above with reference to FIG. 3A.

In FIG. 3B, the noise floor 315-a exceeds the first threshold 305-a. The second threshold 310-a is used to identify FAC values 330-b. The noise floor 315-a may exceed the first threshold 305-a due to a low SNR or NLOS. In some cases, the first threshold 305-a is used if there is LOS and high SNR. The second threshold 310-a may be used in an environment with NLOS and/or with low SNR. It should be noted that there are a number of impulses within the search window 325-a which exceed the first threshold 305-a, but may be attributed to noise, since they are less than the second threshold 310-a and the noise floor 315-a.

The visibility environment may be determined in various ways. In some cases, in a high SNR environment, where SNR is estimated independently from a preamble, the CIR power above the second threshold 310 may be used to determine whether there is a NLOS component. For example, if there is a substantial number of impulses higher than the second threshold 310, but lower than the first threshold 305, it may be determined that the second threshold 310 is detecting NLOS components, while the first threshold 305 is detecting LOS components. Many other methods of determining whether an environment includes NLOS and/or LOS propagation paths, such as using a Rician K-factor, are known to one of skill in the art and not covered in detail for the sake of brevity.

FIG. 3C shows a flow diagram that illustrates a method 300-b for determining a threshold to use, according to various embodiments. The method 300-b may be implemented using and/or as a part of, for example, the devices, systems, and call flow(s) 100, 200, 300, 300-a, 400, 400-a, 500, 600, 700, and 800 of FIGS. 1, 2, 3A, 3B, 4A, 4B, 5, 6, 7, and 8.

At block 335, the SNR may be estimated from the preamble. From this a determination may be made whether the environment is one of a high SNR or a low SNR. Further, as discussed above, the noise floor may be computed based on the preamble at block 340. A second threshold, for example second thresholds 310 or 310-a, may be determined at block 345. Further, a first threshold, for example 305 or 305-a, may be determined at block 345. An estimation may be made whether the environment includes LOS components and/or NLOS components at block 350.

If the ranging environment has a high SNR at block 355, then the difference between the first threshold and the second threshold may be large enough for the second threshold to detect FAC values that the first threshold would not be able to detect. As such the method may proceed to block 365 and use the second threshold. If the ranging environment has a low SNR at block 355 the method may proceed to block 360. At block 360, it is possible that the second threshold is greater than the first threshold and only the second threshold should be used for detecting FAC values, and the method may proceed to block 365. If the second threshold does not exceed the first threshold the method may proceed to block 370.

At block 370, if the environment includes NLOS components, the method may proceed to block 365 and use the second threshold. At block 370, if the environment only includes LOS components, then the method may proceed to block 375 and use the first threshold. Additionally or alternatively, block 370 may be used to determine if the difference between the first threshold and the second threshold is greater than a configurable margin. If the difference is greater than a configurable margin, then both the first and second thresholds may be viable thresholds to use. In this case, a decision may be made, such as based on the presence of LOS and/or NLOS components, whether to use the first threshold and/or the second threshold.

It will be apparent to those skilled in the art that the method 300-b is but an example implementation of the tools and techniques described herein. The method 300-b may be rearranged or otherwise modified such that other implementations are possible.

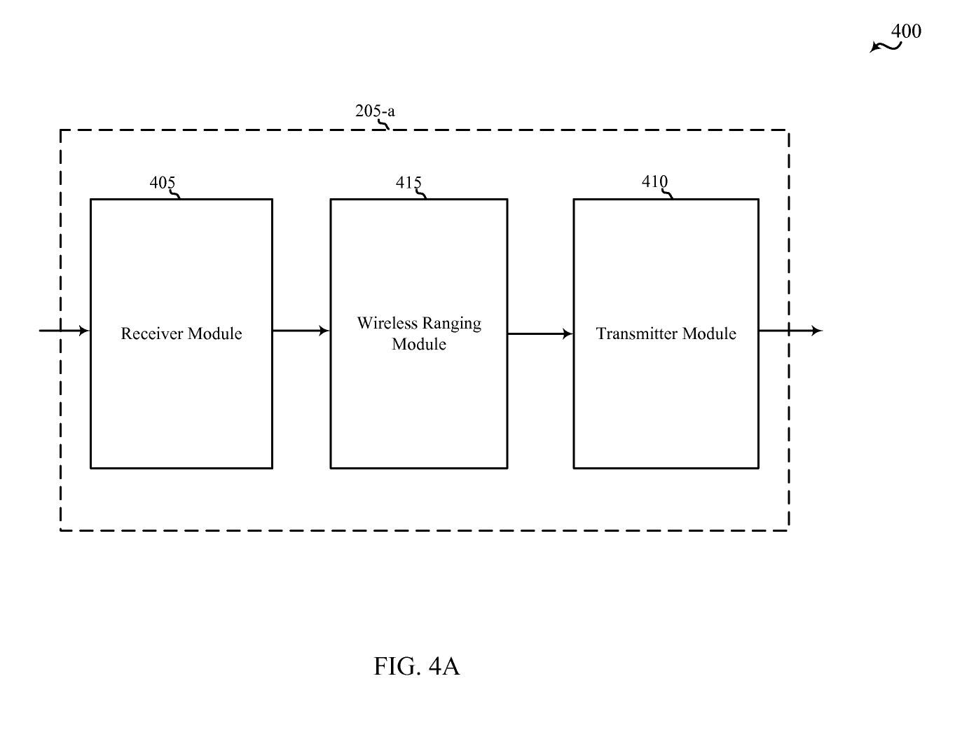

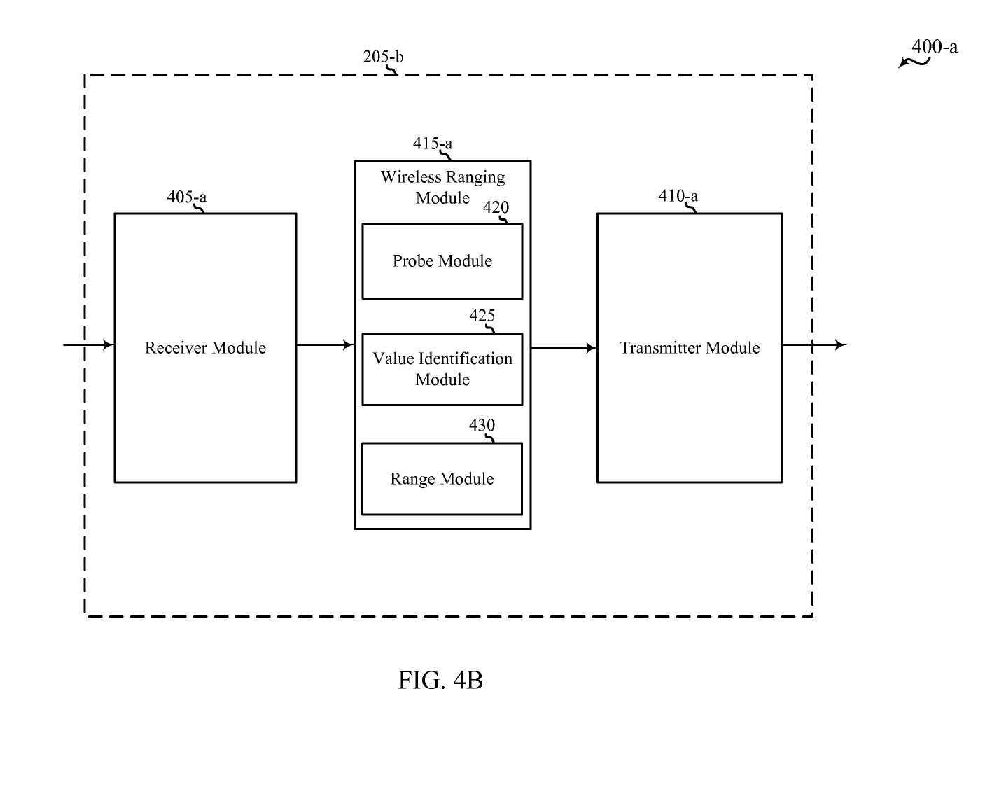

FIG. 4A shows a block diagram illustrating a device 400 configured for wireless ranging in accordance with various embodiments. The device 400 may be a transmitter 205-a, which may be an example of the transmitter 205 of FIG. 2. In some cases, the device 400 may be an example of a receiver 210 of FIG. 2. The device 400 may be an example of a mobile device 115 of FIG. 1. The device 400 may be an example of an access point (AP) (or base station) 105 of FIG. 1. In some embodiments, the device 400 is a processor. The device 400 may include a receiver module 405, a wireless ranging module 415, and/or a transmitter module 410. In some cases, the receiver module 405 and the transmitter module 410 are a single, or multiple, transceiver module(s). The receiver module 405 and/or the transmitter module 410 may include an integrated processor; they may also include an oscillator and/or a timer. The receiver module 405 may receive signals from APs 105, mobile devices 115, transmitters 205, and/or receivers 210. The receiver module 405 may perform operations, or parts of operations, of the system and call flow described above in FIG. 2, including receiving a probe 215 and/or receiving a probe response 225. The transmitter module 410 may transmit signals to APs 105, mobile devices 115, transmitters 205, and/or receivers 210. The transmitter module 410 may perform operations, or parts of operations, of the system and call flow described above in FIG. 2, such as sending a probe 215, sending a probe response 225, and/or sending a range message 260.

The device 400 may include a wireless ranging module 415. The wireless ranging module 415 may include an integrated processor. The wireless ranging module 415 may determine a range to a receiver. The wireless ranging module 415 may identify a strongest path as well as FAC values. The wireless ranging module 415 may determine a threshold to use while identifying FAC values. Further, the wireless ranging module 415 may determine a mean FAC. The wireless ranging module 415 may include a database. The database may store information relating to APs 105, mobile devices 115, transmitters 205, receivers 210, channel conditions, thresholds, and/or ranges.

By way of illustration, the device 400, through the receiver module 405, the wireless ranging module 415, and the transmitter module 410, may perform operations, or parts of operations, of the system and call flow described above with reference to FIG. 2, including transmitting a probe 215, determining a threshold 230, identifying a strongest path 235, identifying FAC values 240, determining a mean FAC 245, adjusting a TOA 250, determining a range 255, and transmitting a range message 260. Further, the device 400, through the receiver module 405, the wireless ranging module 415, and the transmitter module 410, may perform operations, or parts of operations, of the system described above with reference to FIGS. 3A and 3B, including determining a threshold, determining a search window, determining a noise floor, and determining a visibility environment.

FIG. 4B shows a block diagram of a device 400-a configured for wireless ranging in accordance with various embodiments. The device 400-a may be an example of the device 400 of FIG. 4A; and the device 400-a may perform the same or similar functions as described above for device 400. In some embodiments, the device 400-a is a transmitter 205-b, which may include one or more aspects of the transmitters 205 described above with reference to any or all of FIGS. 2 and 4A. In some embodiments, the device 400-a is an example of a receiver 210 described above with reference to FIG. 2. In some embodiments, the device 400-a is an example of a mobile device 115 described above with reference to FIG. 1. In some embodiments, the device 400-a is an example of an AP 105 described above with reference to FIG. 1. The device 400-a may also be a processor. In some cases, the device 400-a includes a receiver module 405-a, which may be an example of the receiver module 405 of FIG. 4A; and the receiver module 405-a may perform the same or similar functions as described above for receiver module 405. In some cases, the device 400-a includes a transmitter module 410-a, which may be an example of the transmitter module 410 of FIG. 4A; and the transmitter module 410-a may perform the same or similar functions as described above for transmitter module 410.

In some embodiments, the device 400-a includes a wireless ranging module 415-a, which may be an example of the wireless ranging module 415 of FIG. 4A. The wireless ranging module 415-a may include a probe module 420. The probe module 420 may perform operations, or parts of operations, of the system and call flow described above in FIG. 2, such as preparing a probe to be transmitted 215, analyzing a probe response 225, determining a threshold 230, identifying a strongest path 235 and/or adjusting a TOA 250. The probe module 420 may perform operations, or parts of operations, of the system described above in FIGS. 3A and/or 3B, such as determining a threshold value, determining a searching window, determining a noise floor, and/or determining a visibility environment.

In some embodiments, the device 400-a includes a value identification module 425. The value identification module 425 may perform operations, or parts of operations, of the system and call flow described above in FIG. 2, such as determining a threshold 230, identifying a strongest path 235, identifying FAC values 240, determining a mean FAC 245, and/or adjusting a TOA 250. The value identification module 425 may perform operations, or parts of operations, of the system described above in FIGS. 3A and/or 3B, such as determining a threshold value, determining a searching window, determining a noise floor, and/or determining a visibility environment.

In some cases, the device 400-a includes a range module 430. The range module 430 may perform operations, or parts of operations, of the system and call flow described above in FIG. 2, such as determining a threshold 230, identifying a strongest path 235, adjusting a TOA 250, determining a range 255, and/or preparing a range message 260.

According to some embodiments, the components of the devices 400 and/or 400-a are, individually or collectively, implemented with at least one application-specific integrated circuit (ASIC) adapted to perform some or all of the applicable functions in hardware. In other embodiments, the functions of device 400 and/or 400-a are performed by at least one processing unit (or core), on at least one integrated circuit (IC). In other embodiments, other types of integrated circuits are used (e.g., Structured/Platform ASICs, field-programmable gate arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

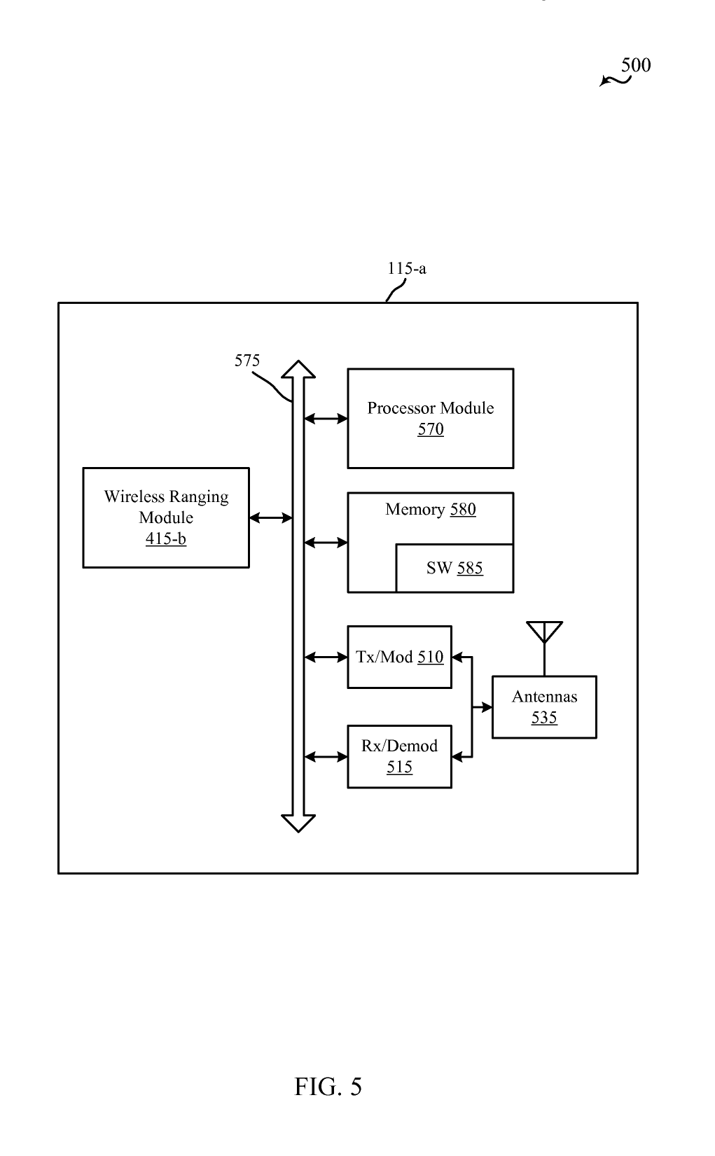

FIG. 5 is a block diagram 500 of a mobile device 115-a configured for wireless ranging, in accordance with various embodiments. The mobile device 115-a may have any of various configurations, such as personal computers (e.g., laptop computers, netbook computers, tablet computers, etc.), cellular telephones, PDAs, smartphones, digital video recorders (DVRs), internet appliances, gaming consoles, e-readers, etc. The mobile device 115-a may have an internal power supply (not shown), such as a small battery, to facilitate mobile operation. In some embodiments, the mobile device 115-a may be an example of the mobile devices 115 of FIG. 1, FIG. 4A and/or FIG. 4B. In some embodiments, the mobile device 115-a may be an example of the transmitters 205 of FIG. 2, FIG. 4A, and/or FIG. 4B. In some embodiments, the mobile device 115-a may be an example of the receivers 210 of FIG. 2, FIG. 4A, and/or FIG. 4B.

The mobile device 115-a may generally include components for bi-directional voice and data communications including components for transmitting communications and components for receiving communications. The mobile device 115-a may include a processor module 570, a memory 580, transmitter/modulators 510, receiver/demodulators 515, and one or more antenna(s) 535, which each may communicate, directly or indirectly, with each other (e.g., via at least one bus 575). The mobile device 115-a may include multiple antennas 535 capable of concurrently transmitting and/or receiving multiple wireless transmissions via transmitter/modulator modules 510 and receiver/demodulator modules 515. For example, the mobile device 115-a may have X antennas 535, M transmitter/modulator modules 510, and R receiver/demodulators 515. The transmitter/modulator modules 510 may be configured to transmit signals via at least one of the antennas 535 to APs 105. The transmitter/modulator modules 510 may include a modem configured to modulate packets and provide the modulated packets to the antennas 535 for transmission. The receiver/demodulators 515 may be configured to receive, perform RF processing, and demodulate packets received from at least one of the antennas 535. In some examples, the mobile device 115-a may have one receiver/demodulator 515 for each antenna 535 (i.e., R═X), while in other examples R may be less than or greater than X. The transmitter/modulators 510 and receiver/demodulators 515 may be capable of concurrently communicating with multiple APs 105 via multiple MIMO layers and/or component carriers.

According to the architecture of FIG. 5, the mobile device 115-a may also include wireless ranging module 415-b. By way of example, wireless ranging module 415-b may be a component of the mobile device 115-a in communication with some or all of the other components of the mobile device 115-a via bus 575. Alternatively, functionality of the wireless ranging module 415-b may be implemented as a component of the transmitter/modulators 510, the receiver/demodulators 515, as a computer program product, and/or as at least one controller element of the processor module 570.

The memory 580 may include random access memory (RAM) and read-only memory (ROM). The memory 580 may store computer-readable, computer-executable software/firmware code 585 containing instructions that are configured to, when executed, cause the processor module 570 to perform various functions described herein (e.g., determining a threshold, identifying a strongest path, identifying a FAC value, determining a mean FAC, adjusting a TOA, determining a range, etc.). Alternatively, the software/firmware code 585 may not be directly executable by the processor module 570 but be configured to cause a computer (e.g., when compiled and executed) to perform functions described herein.

The processor module 570 may include an intelligent hardware device, e.g., a central processing unit (CPU), a microcontroller, an application-specific integrated circuit (ASIC), etc. The mobile device 115-a may include a speech encoder (not shown) configured to receive audio via a microphone, convert the audio into packets (e.g., 20 ms in length, 30 ms in length, etc.) representative of the received audio, provide the audio packets to the transmitter/modulator module 510, and provide indications of whether a user is speaking

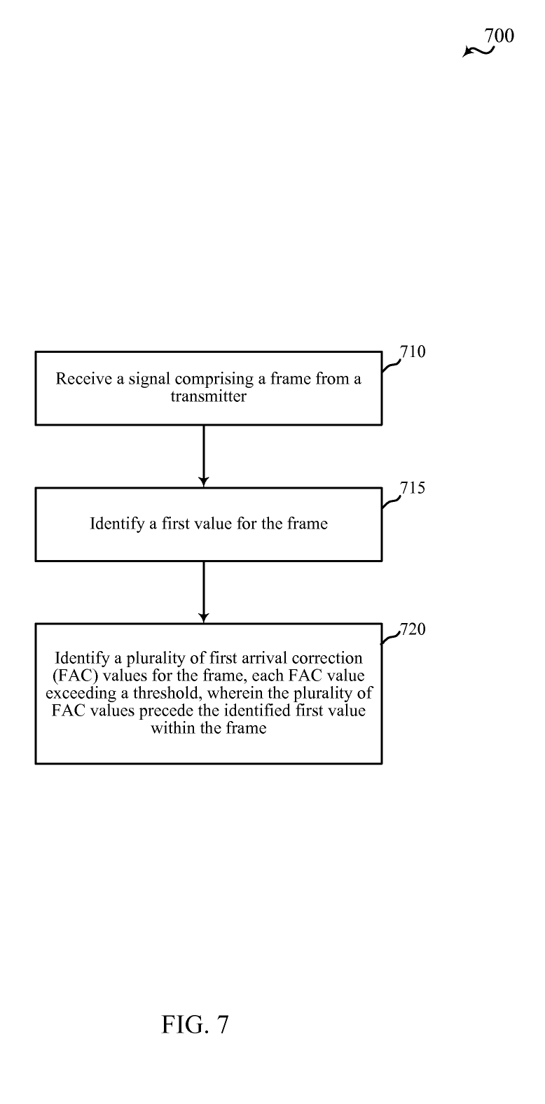

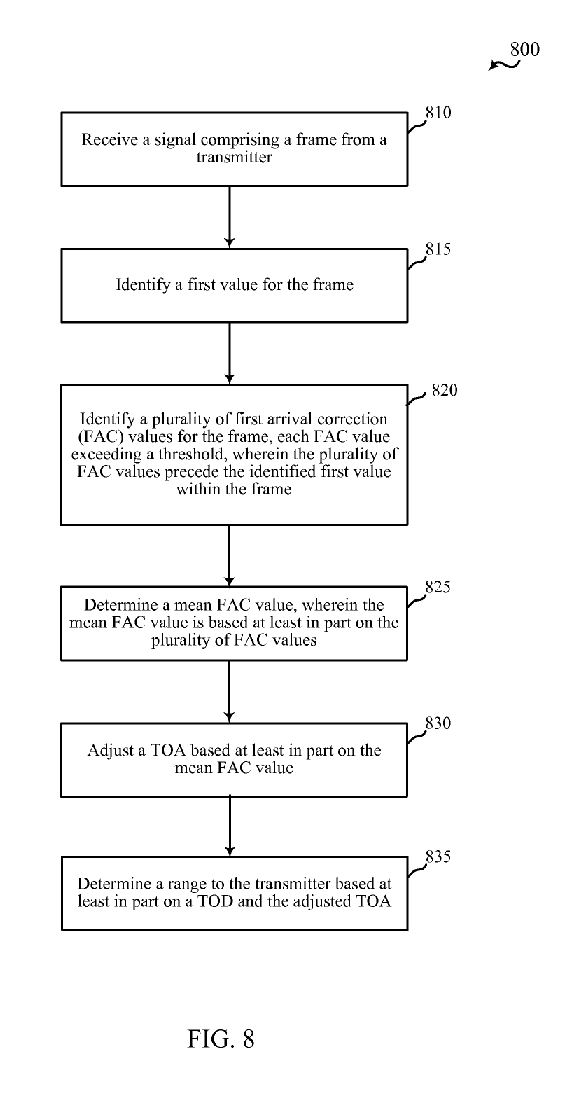

The mobile device 115-a may be configured to implement aspects discussed above with respect to mobile devices 115 of FIG. 1, transmitters 205 of FIG. 2, FIG. 4A, and/or FIG. 4B, receivers 210 of FIG. 2, FIG. 4A, and/or FIG. 4B, or system 300 of FIG. 3A and/or FIG. 3B, and may not be repeated here for the sake of brevity. Thus, wireless ranging module 415-b may include the modules and functionality described above with reference to wireless ranging module 415 of FIG. 4A and/or wireless ranging module 415-a of FIG. 4B. Additionally or alternatively, wireless ranging module 415-b may perform the method 700 described with reference to FIG. 7 and/or the method 800 described with reference to FIG. 8.

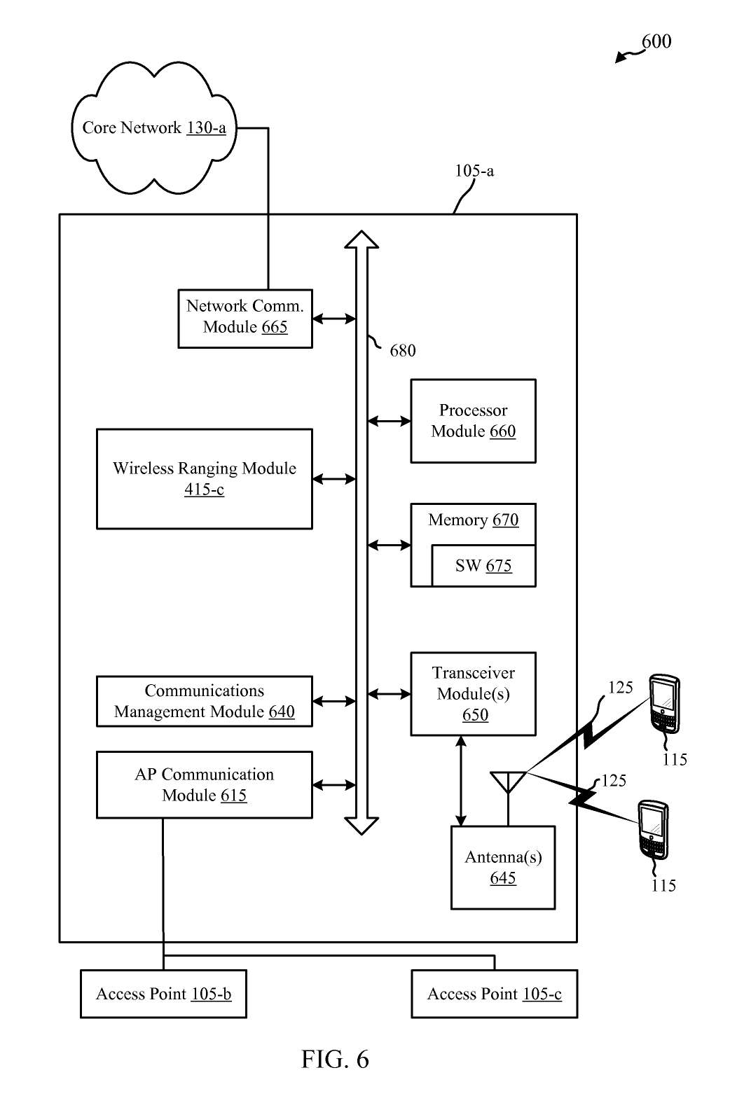

FIG. 6 shows a block diagram of a communications system 600 that may be configured for wireless ranging in accordance with various embodiments. This system 600 may be an example of aspects of the systems 100 or 200 depicted in FIG. 1 or FIG. 2. The system 600 includes an AP 105-a configured for communication with mobile devices 115 over wireless communication links 125. AP 105-a may be capable of communicating over one or more component carriers and may be capable of performing carrier aggregation using multiple component carriers for a communication link 125. AP 105-a may be, for example, an AP 105 as illustrated in system 100, a transmitter 205 as illustrated in system 200, or devices 400 or 400-a, or a receiver 210 as illustrated in system 200.

In some cases, the AP 105-a may have one or more wired backhaul links. AP 105-a may be, for example, an LTE eNB 105 having a wired backhaul link (e.g., S1 interface, etc.) to the core network 130-a. AP 105-a may also communicate with other APs, such as AP 105-b and AP 105-c via inter-base station communication links (e.g., X2 interface, etc.). Each of the APs 105 may communicate with mobile devices 115 using the same or different wireless communications technologies. In some cases, AP 105-a may communicate with other APs such as 105-b and/or 105-c utilizing AP communication module 615. In some embodiments, AP communication module 615 may provide an X2 interface within an LTE/LTE-A wireless communication network technology to provide communication between some of the APs 105. In some embodiments, AP 105-a may communicate with other APs through core network 130-a. In some cases, the AP 105-a may communicate with the core network 130-a through network communications module 665.

The components for AP 105-a may be configured to implement aspects discussed above with respect to APs 105 of FIG. 1, transmitters 205 of FIG. 2, FIG. 4A, and FIG. 4B, receivers 210 of FIG. 2, and system 300 or 300-a of FIG. 3A or FIG. 3B and may not be repeated here for the sake of brevity. For example, AP 105-a may include wireless ranging module 415-c, which may be an example of wireless ranging module 415 of FIG. 4.

The AP 105-a may include antennas 645, transceiver modules 650, memory 670, and a processor module 660, which each may be in communication, directly or indirectly, with each other (e.g., over bus system 680). The transceiver modules 650 may be configured to communicate bi-directionally, via the antennas 645, with the mobile devices 115, which may be multi-mode devices. The transceiver module 650 (and/or other components of the AP 105-a) may also be configured to communicate bi-directionally, via the antennas 645, with other APs (not shown). The transceiver module 650 may include a modem configured to modulate the packets and provide the modulated packets to the antennas 645 for transmission, and to demodulate packets received from the antennas 645. The AP 105-a may include multiple transceiver modules 650, each with at least one associated antenna 645.

The memory 670 may include random access memory (RAM) and read-only memory (ROM). The memory 670 may also store computer-readable, computer-executable software code 675 containing instructions that are configured to, when executed, cause the processor module 660 to perform various functions described herein (e.g., identifying FAC values, determining a mean FAC, adjusting TOA, determining range, etc.). Alternatively, the software 675 may not be directly executable by the processor module 660 but be configured to cause the computer, e.g., when compiled and executed, to perform functions described herein.

The processor module 660 may include an intelligent hardware device, e.g., a central processing unit (CPU), a microcontroller, an application-specific integrated circuit (ASIC), etc. The processor module 660 may include various special purpose processors such as encoders, queue processing modules, base band processors, radio head controllers, digital signal processors (DSPs), and the like.

According to the architecture of FIG. 6, the AP 105-a may further include a communications management module 640. The communications management module 640 may manage communications with other APs 105. The communications management module 640 may include a controller and/or scheduler for controlling communications with mobile devices 115 in cooperation with other APs 105. For example, the communications management module 640 may perform scheduling for transmissions to mobile devices 115, various interference mitigation techniques such as beamforming and/or joint transmission, or various channel condition analysis such as determination of noise floor and/or visibility environment.

FIG. 7 shows a flow diagram that illustrates a method 700 for wireless ranging in accordance with various embodiments. The method 700 may be implemented using, for example, the devices, systems, and call flow(s) 100, 200, 300, 300-a, 300-b, 400, 400-a, 500, and 600 of FIGS. 1, 2, 3A, 3B, 3C, 4A, 4B, 5, and 6.

At block 710, a mobile device 115, AP 105, transmitter 205, receiver 210, and/or some other network component may receive, from a transmitter such as the transmitter 205 or the receiver 210, a signal comprising a frame. For example, the operations at block 710 may be performed by: the wireless ranging module 415 of FIG. 4A; the probe module 420 of FIG. 4B; the device 500 of FIG. 5; and/or the device 600 of FIG. 6.

At block 715, a mobile device 115, AP 105, transmitter 205, receiver 210, and/or some other network component may identify a first value for the frame. For example, the operations at block 715 may be performed by: the wireless ranging module 415 of FIG. 4A; the value identification module 425 of FIG. 4B; the device 500 of FIG. 5; and/or the device 600 of FIG. 6.

At block 720, a mobile device 115, AP 105, transmitter 205, receiver 210, and/or some other network component may identify a plurality of FAC values for the frame, each FAC value exceeding a threshold, wherein the plurality of FAC values precede the identified first value within the frame. In some cases, the operations at block 720 may be performed by: the wireless ranging module 415 of FIG. 4A; the value identification module 425 of FIG. 4B; the device 500 of FIG. 5; and/or the device 600 of FIG. 6.

FIG. 8 shows a flow diagram that illustrates a method 800 for wireless ranging in accordance with various embodiments. The method 800 may be implemented using, for example, the devices, systems, and call flow(s) 100, 200, 300, 300-a, 300-b, 400, 400-a, 500, and 600 of FIGS. 1, 2, 3A, 3B, 3C, 4A, 4B, 5, and 6.

At block 810, a mobile device 115, AP 105, transmitter 205, receiver 210, and/or some other network component may receive, from a transmitter such as the transmitter 205 or the receiver 210, a signal comprising a frame. For example, the operations at block 810 may be performed by: the wireless ranging module 415 of FIG. 4A; the probe module 420 of FIG. 4B; the device 500 of FIG. 5; and/or the device 600 of FIG. 6.

At block 815, a mobile device 115, AP 105, transmitter 205, receiver 210, and/or some other network component may identify a first value for the frame. For example, the operations at block 815 may be performed by: the wireless ranging module 415 of FIG. 4A; the value identification module 425 of FIG. 4B; the device 500 of FIG. 5; and/or the device 600 of FIG. 6.

At block 820, a mobile device 115, AP 105, transmitter 205, receiver 210, and/or some other network component may identify a plurality of FAC values for the frame, each FAC value exceeding a threshold, wherein the plurality of FAC values precede the identified first value within the frame. In some cases, the operations at block 820 may be performed by: the wireless ranging module 415 of FIG. 4A; the value identification module 425 of FIG. 4B; the device 500 of FIG. 5; and/or the device 600 of FIG. 6.

At block 825, a mobile device 115, AP 105, transmitter 205, receiver 210, and/or some other network component may determine a mean FAC value, wherein the mean FAC value is based at least in part on the plurality of FAC values. In some cases, the operations at block 825 may be performed by: the wireless ranging module 415 of FIG. 4A; the value identification module 425 of FIG. 4B; the device 500 of FIG. 5; and/or the device 600 of FIG. 6.

At block 830, a mobile device 115, AP 105, transmitter 205, receiver 210, and/or some other network component may adjust a TOA based at least in part on the mean FAC value. In some cases, the operations at block 830 may be performed by: the wireless ranging module 415 of FIG. 4A; the range module 430 of FIG. 4B; the device 500 of FIG. 5; and/or the device 600 of FIG. 6.

At block 835, a mobile device 115, AP 105, transmitter 205, receiver 210, and/or some other network component may determine a range to the transmitter, such as the transmitter 205 or receiver 210, based at least in part on a TOD and the adjusted TOA. In some cases, the operations at block 835 may be performed by: the wireless ranging module 415 of FIG. 4A; the range module 430 of FIG. 4B; the device 500 of FIG. 5; and/or the device 600 of FIG. 6.

It will be apparent to those skilled in the art that the methods 700 and 800 are but example implementations of the tools and techniques described herein. The methods 700 and 800 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, at least one microprocessor in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable ROM (EEPROM), compact disc ROM (CD-ROM) or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless ranging, comprising:
receiving a signal comprising a frame from a transmitter;
identifying a first value for the frame; and
identifying a plurality of first arrival correction (FAC) values for the frame, each FAC value exceeding a threshold, wherein the plurality of FAC values precede the identified first value within the frame.

2. The method of claim 1, wherein the threshold is based at least in part on a noise power.

3. The method of claim 1, wherein the plurality of FAC values comprise a plurality of searched FAC values which each exceed the threshold, wherein the plurality of searched FAC values each occur within a search window.

4. The method of claim 1, further comprising:
determining a mean FAC value, wherein the mean FAC value is based at least in part on the plurality of FAC values.

5. The method of claim 4, wherein the plurality of FAC values are weighted proportional to a power of each FAC value.

6. The method of claim 4, wherein the plurality of FAC values are weighted inversely proportional to a power of each FAC value.

7. The method of claim 4, further comprising:
determining a range to the transmitter based at least in part on the mean FAC value.

8. The method of claim 1, wherein identifying the plurality of FAC values which each exceed the threshold comprises:
determining an appropriate threshold, wherein the appropriate threshold is one of a plurality of thresholds; and
identifying the plurality of first arrival correction (FAC) values which each exceed the appropriate threshold.

9. The method of claim 8, wherein at least one of the plurality of thresholds is based at least in part on a noise power.

10. The method of claim 8, wherein at least one of the plurality of thresholds is based at least in part on the first value for the frame.

11. The method of claim 8, wherein determining an appropriate threshold is based at least in part on at least one of a signal to noise ratio and a visibility environment.

12. The method of claim 1, wherein the first value for the frame comprises a maximum value for the frame.

13. The method of claim 1, wherein the frame comprises a time of departure (TOD) and a time of arrival (TOA).

14. The method of claim 13, further comprising:
adjusting the TOA based at least in part on the plurality of FAC values.

15. The method of claim 14, further comprising:
determining a range to the transmitter based at least in part on the TOD and the adjusted TOA.

16. The method of claim 1, wherein the frame comprises at least one of a probe and a response indicating receipt of a probe.

17. An apparatus for wireless ranging, comprising:
a receiver configured for receiving, from a transmitter, a signal comprising a frame;
a path identifier configured for identifying a first value for the frame; and
a corrector configured for identifying a plurality of first arrival correction (FAC) values for the frame, each FAC value exceeding a threshold, wherein the plurality of FAC values precede the identified first value within the frame.

18. The apparatus of claim 17, wherein the threshold is based at least in part on a noise power.

19. The apparatus of claim 17, wherein the plurality of FAC values comprise a plurality of searched FAC values which each exceed the threshold, wherein the plurality of searched FAC values each occur within a search window.

20. The apparatus of claim 17, further comprising:
a combiner configured for determining a mean FAC value, wherein the mean FAC value is based at least in part on the plurality of FAC values.

21. The apparatus of claim 20, wherein the plurality of FAC values are weighted proportional to a power of each FAC value.

22. The apparatus of claim 20, wherein the plurality of FAC values are weighted inversely proportional to a power of each FAC value.

23. The apparatus of claim 20, further comprising:
a ranger configured for determining a range to the transmitter based at least in part on the mean FAC value.

24. The apparatus of claim 17, wherein identifying the plurality of FAC values which each exceed the threshold comprises:
determining an appropriate threshold, wherein the appropriate threshold is one of a plurality of thresholds; and
identifying the plurality of first arrival correction (FAC) values which each exceed the appropriate threshold.

25. The apparatus of claim 24, wherein at least one of the plurality of thresholds is based at least in part on at least one of a noise power and the first value for the frame.

26. The apparatus of claim 24, wherein determining an appropriate threshold is based at least in part on at least one of a signal to noise ratio and a visibility environment.

27. The apparatus of claim 17, wherein the frame comprises a time of departure (TOD) and a time of arrival (TOA).

28. The apparatus of claim 27, further comprising:
an adjuster configured for adjusting the TOA based at least in part on the plurality of FAC values; and
a ranger configured for determining a range to the transmitter based at least in part on the TOD and the adjusted TOA.

29. An apparatus for wireless ranging, comprising:
means for receiving, from a transmitter, a signal comprising a frame;
means for identifying a first value for the frame; and
means for identifying a plurality of first arrival correction (FAC) values for the frame, each FAC value exceeding a threshold, wherein the plurality of FAC values precede the identified first value within the frame.

30. A computer-program product for wireless ranging, the computer-program product comprising a non-transitory computer-readable medium storing instructions executable by a processor to:
receive, from a transmitter, a signal comprising a frame;
identify a first value for the frame; and
identify a plurality of first arrival correction (FAC) values for the frame, each FAC value exceeding a threshold, wherein the plurality of FAC values precede the identified first value within the frame.
